(19) United States
(12) Patent Application Publication
(10) Pub. No.: US 2003/0091834 A1
(43) Pub. Date: May 15, 2003

(54) Coated plastic molding

(75) Inventors: Hiroshi Watarai, Nishikasugai-gun (JP); Hiroki Hattori, Nishikasugai-gun (JP); Junji Koizumi, Nishikasugai-gun (JP); Katsushi Ito, Nishikasugai-gun (JP)

Correspondence Address: PILLSBURY WINTHROP, LLP, P.O. BOX 10500, MCLEAN, VA, 22102, US

(73) Assignee: TOYODA GOSEI, LTD.

(21) Appl. No.: 10/189,142

(22) Filed: Jul. 5, 2002

Related U.S. Application Data
(63) Continuation-in-part of application No. 09/288,636, filed on Apr. 9, 1999, now abandoned.

(30) Foreign Application Priority Data
Apr. 9, 1998 (JP) P10-097296

(51) Int. Cl. B32B 27/00

(52) U.S. Cl. 428/424.2; 428/423.1

(57) ABSTRACT

A coated plastic molding having a final coating on a molding body formed of plastic material and having elastic modulus in tension of from about 10 to about 2,000 MPa. The coated plastic molding has such a relationship that a ratio E′/E is 0.5 or more when the elastic modulus in tension of the molding body is E and the elastic modulus in tension of the final coating is E′.

This is a Continuation-In-Part of U.S. application Ser. No. 09/288,636, filed on Apr. 9, 1999, which claims priority from Japanese Patent Application No. Hei. 10-97296, filed Apr. 9, 1998.

### BACKGROUND OF THE INVENTION

1. Field of the Invention

The present invention relates to a coated plastic molding having a final coating (over coating) on a molding body molded with plastic material. Particularly, the present invention relates to a coated plastic molding suitable for decorative parts and so on of automobiles, which is required to have scuffing resistance as well as weatherability and good appearance.

Examples of the decorative parts of automobiles include bumpers, side moldings and side garnishes which may be formed of non-rigid or rigid plastic moldings, and wheel caps which may be formed of mainly rigid plastic moldings, etc. Here, the words non-rigid, semirigid and rigid are used conceptually, but they are in accordance with the definition in ASTM D 838. That is, non-rigid, semirigid and rigid plastic materials have bending moduli of elasticity smaller than 70 MPa, not smaller than 70 MPa but smaller than 700 MPa, and larger than 700 MPa, respectively.

Here, a coated polyolefin molding in which a final coating (over coating) of acryl-urethane paint (thermosetting) is applied onto a polyolefin molding of polypropylene or the like will be mainly described by way of example of a coated plastic molding. However, the present invention is not limited thereto.

2. Description of the Related Art

Polyolefin, represented by PP or a PP polymer alloy, is relatively light in weight, superior in antiweatherability, and low in cost in comparison with another polymer. Therefore, polyolefin is widely used, in place of conventionally used polyvinyl chloride or the like, as material of moldings of automobile parts which are strongly required to be reduced in weight.

However, polyolefin moldings are inferior in wear resistance and scuffing resistance, in the state as they are. Accordingly, polyolefin moldings in which an under coating is formed with chlorinated PP paint and a final coating is formed with acryl-urethane paint regarded as superior in scuffing resistance are well known (Japanese Patent Publication No. Hei. 6-145382, 6-145388 and 7-278488, and so on).

On the other hand, in a side molding or the like, foreign substances deposited on the side molding may be scraped off with human nails or the like after the side molding is attached to an automobile. When wax or foreign matter exists in a space between a side molding body 12 and a vehicle body 14 or a metallic color trim 16, the wax or foreign matter may be removed with a resin plate (squeegee) 18 or the like having a sharp point (see FIG. 1). The scuffing resistance of a final coating 13 was insufficient when such a matter was scratched with such a sharp-pointed one. That is, the final coating 13 was apt to be damaged.

However, it was found that, when acryl-urethane paint is applied to molding bodies comprising olefin plastic material or the like, there were some cases where sufficient scuffing resistance could be obtained while in the other cases where it could not be obtained, in accordance with the kind of molding bodies.

In such a case, it can be considered that acryl-urethane paint with high hardness or high elastic modulus is used. But, there is a problem on adherability or there is a fear of incurring excess quality.

### SUMMARY OF THE INVENTION

Taking the foregoing problems into consideration, it is an object of the present invention to provide a coated plastic molding having a final coating in which stable scuffing resistance can be designed in the coating.

Through diligent efforts for development to solve the foregoing problems, the present inventors found that a coated plastic molding superior in scuffing resistance could be obtained stably if a predetermined relationship was established between the elastic modulus in tension of a molding body and the elastic modulus in tension of a coating. Thus, the present inventors have thought of the coated plastic molding having the following configuration.

According to the present invention, there is provided a coated plastic molding having a final coating on a molding body molded with plastic material and having elastic modulus in tension in a range of from about 10 to about 2,000 MPa. Especially, a ratio E′/E is not smaller than 0.5, wherein E represents the elastic modulus in tension (according to ASTM D 638) of the molding body, and E′ represents the elastic modulus in tension (according to JIS K 7244-4) of the coating.

In the above-mentioned configuration, it is preferable that the ratio E′/E is not larger than 5.

In addition, it is preferable to use a combination in which the plastic material with which the molding body is to be molded is composed of a group of polyolefin and the paint for the final coating is composed of a group of acryl-urethane.

Features and advantages of the invention will be evident from the following detailed description of the preferred embodiments described in conjunction with the attached drawings.

### BRIEF DESCRIPTION OF THE DRAWINGS

In the accompanying drawings:

FIG. 1 is a sectional view showing an attachment state of a molding as an example of a coated plastic molding to which the present invention is applied;

FIG. 2 is a perspective view for explaining the form of a scratching member used in examination of scratch resistance; and

FIG. 3 is a graph in which the result of the examination of scratch resistance was plotted on a diagram of the relationship of elasticity modulus (E′) of coating/base elasticity modulus (E) of base.

### DETAILED DESCRIPTION OF THE PREFERRED EMBODIMENTS

In the following description, the compound unit and ratio are expressed by weight unless a notice is especially given.

A. Compositions of the Coated Plastic Molding

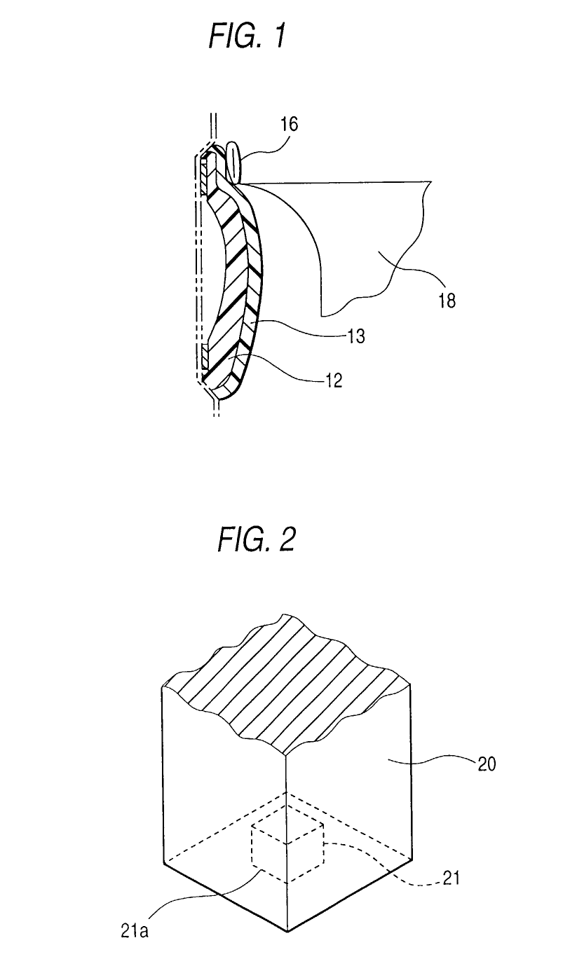

It is set forth as a premise that a coated plastic molding according to the present invention has a final coating 13 applied onto a molding body (base) 12 molded with plastic material having elastic modulus in tension of about 10 to about 2,000 MPa (see FIG. 1).

(1) Here, it is difficult to keep the form of the molding body (base) if the elastic modulus in tension is smaller than 10 MPa. On the other hand, if it is larger than 2,000 MPa, the surface of the molding body is so hard that the necessity to form a coating for giving scuffing resistance on the molding body is reduced.

The above-mentioned plastic material is not specifically limited so long as its elastic modulus in tension is within the aforementioned range. However, in view of increasing the effect of the invention, it is preferable to use, as the plastic material, materials which are not sufficient in scuffing resistance property including: polar material such as soft PVC, etc.; polyethylene (PE), polypropylene (PP), or olefin plastic material using polyethylene or polypropylene as base; thermoplastic elastomer (TPE) such as amide material, ester material, or the like.

Particularly, of them, olefin plastic material is preferable. This is because olefin plastic material is relatively light in weight, superior in weatherability, and low in cost, in comparison with any other polymer.

As the olefin plastic material, non-rigid, semirigid and rigid type olefin plastic material may be used.

As the non-rigid type olefin plastic material, TPEs of styrene, olefin, and 1,2-PB; and polymer alloys of those TPEs may be used. Of the styrene TPE, PS-polyethylene/polybutylene-PS (generally abbreviated as “SEBS”) is preferable because it is superior in strength and good in coating adherence in comparison with other soft polyolefin.

As the rigid type olefin plastic material, polypropylene (PP), polyethylene (PE), polyallomer, etc. may be used desirably, or a rubber component such as ethylene propylene rubber, etc. may be mixed to PP to thereby form semirigid PP.

Further, such olefin plastic material is mixed with inorganic pigment, inorganic filler such as talc, etc., and auxiliary material such as anti-aging agent etc. to thereby prepare molding material.

As the molding method, molding may be performed by general injection, extrusion, etc., without being limited specifically.

(2) The above-mentioned final coating may be formed with thermoplastic paint, but it may be formed, preferably, with thermosetting paint because scuffing resistance can be obtained easily in the coating.

Examples of the thermosetting paint include various kinds of urethane such as acryl-urethane, ester-urethane, etc.; melamine, unsaturated polyester, or denatured paint of those; and so on. Of them, acryl-urethane paint is preferable because it is easy to obtain adhesion with a molding body, particularly a molding body formed of olefin plastic material, and to obtain scuffing resistance in coating.

As the acryl-urethane paint, for example, it is possible to use preferably that having the following composition.

The polymer for the acryl-urethane paint comprises a polyol component and a polyisocyanate component.

(i) In the polymer used for the acryl-urethane paint, the polyol component contains the following (a) to (c) components.

(a) Main component: acryl graft chlorinated polyolefin (PO) (hereinafter referred to as “AG chlorinated PO”) in which acrylmonomer containing hydroxyl introduced matter (OH introduced matter) is graft-polymerized so that hydroxyl group (OH) is introduced into chlorinated PO with a chlorination ratio of from 20 to 30%

(b) An essential component: high polymeric acryl polyol having a glass transition point not lower than 5° C.

(c) Another essential component: high polymeric polyester polyol having a glass transition point not higher than 10° C.

The polyol component is prepared so as to have a glass transition point not lower than 50° C. as a whole.

(ii) As the AG chlorinated PO, used is that having a glass transition point (T_{g}) in a range of from 15 to 60° C., preferably from 35 to 35° C., and having an average molecular weight (M_{w}) in a range of from 20 thousand to 100 thousand, preferably from 30 thousand to 50 thousand. In addition, it is preferable to use AG chlorinated PO having an OH value in a range of from 5 to 40 mg/g, preferably from 15 to 35 mg/g.

The OH value means the mg weight of potassium hydrate equivalent to hydroxyl group contained in a specimen of 1 g.

(α) Examples of the above-mentioned chlorinated PO include chlorinated PE, chlorinated PP, chlorosulfonated PE, chlorosulfonated PP, etc.

At this time, chlorinated PP is particularly preferably used because the chlorinated PP which has chlorination in the range of from 20 to 30% and which is superior in coating adhesion can be easily prepared. The chlorinated PP having chlorination in the range of from 20 to 30% is preferable because not only it is superior in coating adhesion, weatherability and solvent resistance of the cured coating but also it is easy to make it into paint.

(β) Examples of the OH introduced matter of the acryl monomer include hydroxyethyl acrylate, hydroxypropyl methacrylate, hydroxyethyl methacrylate, hydroxypropyl methacrylate, etc.

Examples of the acryl monomer other than OH introduced matter include acrylic acid, methyl acrylate, ethyl acrylate, n-butyl acrylate, 2-ethylhexyl acrylate, lauryl acrylate, methacrylic acid, methyl methacrylate, ethyl methacrylate, n-butyl methacrylate, 2-ethylhexyl methacrylate, lauryl methacrylate, etc.

Here, the ratio by weight of acryl graft to chlorinated PO (acryl graft/chlorinated PO) is set to be within a range of from 95/5 to 60/40, preferably from 90/10 to 70/30.

(iii) As the above-mentioned high polymeric acryl polyol having a glass transition point (T_{g}) not lower than 5° C., that which has a hydroxyl value in a range of from 5 to 60 mg/g, preferably from 10 to 35 mg/g is used.

The high polymeric acryl polyol can be prepared by copolymerizing acryl monomer which contains the above-mentioned OH introduced matter by a suitable amount of the OH introduced matter.

Generally, the glass transition point T_{g} increases in proportion to the increase of the OH value, so that the glass transition point T_{g} within a range of from 0 to 60° C. can be obtained easily.

(iv) The high polymeric polyester polyol the glass transition point (T_{g}) of which is not higher than 10° C. can be prepared by polycondensation reaction among polyol having functionality not smaller than 2, dicarboxylic acid, and COOH with excessive OH.

Here, ethylene glycol, neopentyl glycol, 1,8-octamethylenediol, etc. can be preferably used as the polyol. Adipic acid, maleic acid, fumaric acid, phthalic acid, sebacic acid, etc. can be preferably used as the dicarboxylic acid.

Examples of the high polymeric polyester polyol include polyethylene adipate, polybuthylene adipate, polyhexamethylene adipate, etc. In addition, polycaprolactonediols prepared by ring opening polymerization of lactone may be also used.

In addition, the OH value is set to be not smaller than 50 mg/g, preferably in a range of from 50 to 250 mg/g, more preferably from 180 to 250 mg/g.

(v) Although the polyisocyanate component is not specifically limited, those which are so-called non-yellowing matters such as a aliphatic group and cycloaliphatic group described below may be preferably used in the case of moldings, which dislike yellowing, such as decorative parts of automobiles. In the case of moldings to be used indoors, however, those of an aromatic group described below may be used. Of those of an aliphatic group, that which contains a benzene ring such as XDI, or that which is of a cycloaliphatic type such as hydrated MDI is preferable because it can give rigidity to crosslinked moleculars so as to give scratch resistance with increase of hardness in comparison with other materials of the aliphatic group.

The mixing ratio of the polyole component and the polyisocyanate component is generally set to be substantially equivalent in weight, that is, 1.2/1 to 1/1.2, preferably 1.1/1 to 1/1.1.

(α) Aliphatic or Cycloaliphatic Isocyanate

Examples of aliphatic or cycloaliphatic isocyanate include so-called non-yellowing matters such as hexamethylene di-isocyanate (HMDI), xylenedi-isocyanate (XDI), hydrated xylene di-isocyanate (hydrated XDI), 4,4′-methylene bis-dicyclohexyl di-isocyanate (hydrated MDI), methyl cyclohexyl di-isocyanate (hydrated TDI), isophorone di-isocyanate (IPDI), etc. and further include, in view of handling, so-called non-yellowing matters such as dimers, trimers, trimethylolpropane adducts, prepolymers, etc. prepared by polymerization of those materials mentioned above.

(β) Aromatic Isocyanate

Examples of aromatic isocyanate include 4,4′-diphenylmethane di-isocyanate (hereinafter abbreviated to “MDI”), crude MDI, liquid MDI, tolylene di-isocyanate, phenylene di-isocyanate, etc. and further include, in view of handling, dimers, trimers, trimethylolpropane adducts, prepolymers, etc. prepared by polymerization of those materials mentioned above.

Here, the compounding ratio of the above-mentioned components (a), (b) and (c) is set to be as follows. That is, with respect to 100 parts of the component (a), the component (b) is set to be in a range of from 5 to 60 parts, preferably from 15 to 50 parts, more preferably from 15 to 45 parts, and the component (c) is set to be in a range of from 5 to 40 parts, preferably from 5 to 30 parts, more preferably from 8 to 25 parts. The ratio by weight is set as follows. That is, the ratio (b)/(c) is set to be in a range of from 3/7 to 9.5/0.5, preferably from 4/6 to 9/1, more preferably from 6/4 to 9/1.

B. Elastic Modulus in Tension

In the above-mentioned coated plastic molding, the ratio E′/E is not smaller than 0.5 (preferably, not smaller than 0.6), wherein E represents the elastic modulus in tension of the molding body and E′ represents the elastic modulus in tension of the coating.

Thus, it becomes easy to design a coated plastic molding having scuffing resistance in the coating, as shown in examples which will be described later.

If the ratio E′/E is smaller than 0.5, it is difficult to obtain predetermined scuffing resistance. Although the upper limit of the ratio E′/E is not specifically defined, it is generally set to be 5, preferably in a range of from 1.5 to 2.5. This is because the scuffing resistance shows a plateau within a range of from 0.5 to such a value (1.5 to 2.5) (particularly, it is conspicuous when the elastic modulus intension of plastic material is within a range of from 400 to 1,000 MPa. See Table 2).

The above-mentioned final coating paint is not specifically limited so long as the paint has elastic modulus in tension of coating which is 0.5 times or more as large as the elastic modulus in tension of the molding body and can form a coating having adhesion to the molding body. The form of the paint is desirably selected from solvent-based, suspended, latex, powder, etc. In addition, the coating method can be selected desirably, in accordance with the form of the paint, from brush coating, dip coating, spray coating, electrostatic coating, electrodeposition coating, etc.

C. Method of Manufacturing the Coated Molding

Next, description will be made about a manufacturing method of the above-mentioned coated molding.

(1) A plastic molding body molded in advance is cleansed with alcohol such as IPA or the like. This cleansing process may not be necessary if the plastic molding body is clean.

(2) Next, a base coating (primer layer) is formed with undercoating paint on the molding body. Then, a final coating paint is applied onto the base coating. Although it is preferable to form the base coating in view of adhesion, the base coating is not always necessary if the final coating has enough adhesion to the base.

As the undercoating paint, a well-known paint with a base of chlorinated PP as disclosed in the above-mentioned publication may be used.

Particularly, as the base coating, a “solvent undercoating paint with a base of chlorinated polyolefin (chlorinated PO) comprising carboxyl group introduced matter and acryl graft polymerized matter” disclosed in Japanese Patent Publication No. Hei. 7-278488 may be used preferably.

(3) The resin coated molding manufactured thus is superior in scuffing resistance of its coating, as shown in examples which will be described later.

As stated above, in the coated plastic molding having a final coating on a molding body molded with plastic material and having elastic modulus in tension in a range of from about 10 to about 2,000 MPa, according to the present invention, a ratio E′/E is not smaller than 0.5 where E represents the elastic modulus in tension of the molding body, and E′ represents the elastic modulus in tension of the coating. Accordingly, the coated plastic molding exhibits the following effects.

That is, the coated plastic molding is superior in scuffing resistance of its coating if the ratio E′/E is set to be 0.5 or more, as shown in examples which will be described later. Therefore, from materials having adhesion between the final coating and the base or between the final coating and the primer layer, if material which satisfies the above-mentioned condition with respect to the elastic modulus in tension of a coating is selected, it will go well. Accordingly, the design of coating becomes easy.

The reason why the scuffing resistance is superior under the above-mentioned condition is believed to be as follows.

If the coating has an elastic modulus in tension which is not so smaller than that of the base, or which is larger than that of the base, external force acting on the coating can be given also to the base, so that the final coating may have predetermined scuffing resistance. On the contrary, if the elastic modulus in tension of the coating is too much smaller than that of the base, the external force acting on the coating is given only to the coating, so that the coating is easily damaged.

D. Experimental Examples

Description will be made below about experimental examples where the configuration of the present invention (the ratio E′/E is 0.5 or more) has been induced.

(1) Preparation of Samples

Automobile side moldings (molding bodies) were injection-molded by using PP or PVC material, as molding material, having compositions shown in Table 1 and having elastic modulus in tension shown in Table 2. Block PP containing ethylene 10% by weight was used as PP, and bipolymer containing propylene 25% by weight was used as EPR.

After being wiped with isopropyl alcohol (IPA), the molding bodies (bases) were coated by spray coating, with undercoating paint (a solvent type paint with a base in which the ratio of chlorinated polyolefin of carboxyl group introduced matter/acryl graft polymerized matter was 9/4) of the following composition and dried by air to thereby obtain a primary coating to a thickness of 10 μm.

Final coating paint (examples and comparative examples) which were of the types shown in Table 2 and which had elastic modulus in tension shown in Table 2 were applied by spraying to a dried thickness of 30 μm and heated at 80° C. for 30 minutes to thereby form a final coating.

(2) Test Method

Scratch resistance of the coating was tested in the following method. There was no problem in adhesion of each coating.

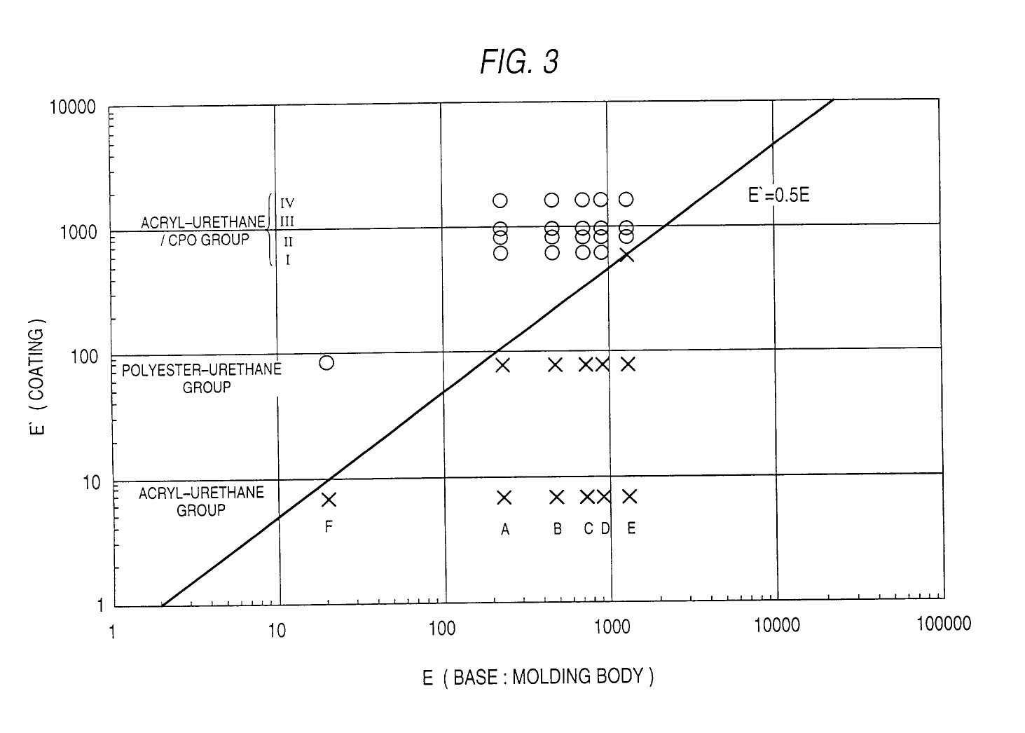

The result was shown in Table 2 and plotted in FIG. 3. It can be induced that the superior scratch resistance (scuffing resistance) can be obtained if the ratio E′/E is set to be 0.5 or more.

<Scratch Resistance>

With respect to the moldings, scratch resistance was tested in the following method and under the following conditions. That is, the number of times of scratching was counted until the coating was peeled off so that the primary coating applied on the molding body was exposed, while such a scratching member (2 cm²: width 0.02 m and length 0.02 m) 20 as shown in FIG. 2 was held at the head of a chuck of an abrader (“flatbed friction tester NR-100” made by Daiei Kagaku Seiki Co., Ltd.) so that the direction of an edge 21a of a head protrusion portion (1 cm²×protrusion length of 3 mm) 21 of the scratching member 20 was made to be coincident with the scratching direction.

Scratching member: made of chrome-plated brass

Test conditions: loading 500 g, reciprocating distance 60 mm, and velocity 50 reciprocations/min

TABLE 1

| | Composition | | |
|---|---|---|---|
| plastic material | PP | EPR | talc |
| A | 40 | 60 | — |
| B | 43 | 50 | 7 |
| C | 50 | 43 | 7 |
| D | 50 | 40 | 10 |
| E | 60 | 30 | 10 |

| | |
|---|---|
| F | PVC/DOP/calcium carbonate = 67/27/6 |

DOP: dioctyl phthalate
(unit: weight %)

TABLE 2

| molding body | | A | B | C | D | E | F |
|---|---|---|---|---|---|---|---|
| final coating | | 230 MPa | 480 Mpa | 740 MPa | 930 MPa | 1370 MPa | 20 MPa |
| acryl urethane | 7.2 MPa | 2 X | 2 X | 2 X | 2 X | 1 X | 23 X |
| (II) | | 0.03 | 0.02 | 0.01 | 0.01 | 0.005 | 0.36 |
| polyester | 83 MPa | 23 X | 6 X | 6 X | 2 X | 4 X | 77 O |
| urethane | | 0.36 | 0.17 | 0.11 | 0.09 | 0.06 | 4.15 |
| Acryl | 640 MPa | 57 O | 55 O | 31 O | 33 O | 20 X | — |
| urethane/ | | 2.78 | 1.33 | 0.86 | 0.69 | 0.47 | |
| CPO | | | | | | | |
| (I) | | | | | | | |
| the same | 853 MPa | 100 O | 60 O | 60 O | 60 O | 70 O | — |
| (II) | | 3.71 | 1.79 | 1.15 | 0.92 | 0.62 | |
| the same | 1000 MPa | 70 O | 50 O | 50 O | 50 O | 50 O | — |
| (III) | | 4.35 | 2.08 | 1.35 | 1.08 | 0.73 | |
| the same | 1700 MPa | 60 O | 50 O | 50 O | 50 O | 45 O | — |
| (IV) | | 7.39 | 3.54 | 2.30 | 1.83 | 1.24 | |

the upper row: number of times until base material was exposed
the lower row: E′/E
X: failure
O: good

Although the invention has been described in its preferred form with a certain degree of particularity, it is understood that the present disclosure of the preferred form can be changed in the details of construction and in the combination and arrangement of parts without departing from the spirit and the scope of the invention as hereinafter claimed.

What is claimed is:

1. A coated plastic molding comprising:
a molding body being molded with polyolefin plastic material, and having an elastic modulus in tension in a range of from 230 to about 2,000 MPa; and
a final coating comprising acryl-urethane paint provided on said molding body,
wherein a ratio E′/E is not smaller than 0.5, wherein E represents the elastic modulus in tension of said molding body according to ASTM D 638, and E′ represents elastic modulus in tension of said final coating according to JIS K 7244-4, and
wherein said final coating resists a minimum of 30 reciprocal scratches applied by an abrading apparatus in substantially the same location under defined loading and velocity conditions before peeling.

2. A coated plastic molding according to claim 1, wherein said ratio E′/E is not larger than 5.

3. A coated plastic molding according to claim 1, wherein said acryl-urethane paint comprises a polyol component and a polyisocyanate component.

4. A coated plastic molding according to claim 3, wherein said polyol component comprises:
acryl graft chlorinated PO;
polymeric acryl polyol having a glass transition point not lower than 5° C.; and
polymeric polyester polyol having a glass transition point not higher than 10° C.

5. A coated plastic molding according to claim 3, wherein said polyisocyanate component comprises aliphatic polyisocyanate.

6. A coated plastic molding according to claim 3, wherein said polyisocyanate component comprises cycloaliphatic polyisocyanate.

7. A coated plastic molding according to claim 3, wherein said polyisocyanate component comprises aromatic polyisocyanate.

8. A coated plastic molding according to claim 1, wherein the ratio E′/E is not smaller than 0.6 and not larger than 2.5.

9. A coated plastic molding according to claim 1, wherein the defined loading and velocity conditions comprise a load of 500 g applied by the abrading apparatus at a velocity of 50 reciprocations per minute.

10. A coated plastic molding, comprising:
a molding body being molded with polyolefin plastic material, and having an elastic modulus in tension in a range of from 230 to about 2,000 MPa; and
a final coating comprising acryl-urethane paint provided on said molding body, wherein a ratio E′/E is not smaller than 0.5, wherein E represents the elastic modulus in tension of said molding body, and E′ represents elastic modulus in tension of said final coating, and
wherein said final coating resists a minimum of 30 reciprocal scratches applied by an abrading apparatus in substantially the same location under defined loading and velocity conditions before peeling.
